(19) United States
(12) Patent Application Publication
(10) Pub. No.: US 2011/0315126 A1
(43) Pub. Date: Dec. 29, 2011

(54) CARBON CANISTER

(75) Inventors: Hiroyuki YOSHIDA, Hiki-gun (JP); Takashi HASUMI, Tokyo (JP)

(73) Assignee: MAHLE FILTER SYSTEMS JAPAN CORPORATION

(21) Appl. No.: 13/165,279

(22) Filed: Jun. 21, 2011

(30) Foreign Application Priority Data
Jun. 23, 2010 (JP) 2010-142216

(51) Int. Cl. F02M 33/02

(52) U.S. Cl. 123/519

(57) ABSTRACT

In a carbon canister including a casing with first and second casing parts connected through a passage, a first type of granulated adsorbing material 14, 19 packed in the first and s second casing parts, a charge port pipe 9 connected to the first casing part, a purge port pipe 10 connected to the first casing part, an air inlet pipe 11, 34 fluidly connected to the second casing part, there is provided an additional carbon canister section CC, 32 between the air inlet pipe 11,34 and the second casing, the additional carbon canister section containing therein a second type of granulated adsorbing material 23 of which fuel vapor adsorbing/clearing ability is equal to or higher than that of the first type of granulated adsorbing material 14, 19.

### BACKGROUND OF THE INVENTION

1. Field of the Invention

The present invention relates in general to an evaporative control system of a motor vehicle powered by fuel such as gasoline or the like, and more particularly to a carbon canister installed in the evaporative control system, which adsorbs fuel vapor from a fuel tank of the motor vehicle and when the engine starts, feeds the fuel vapor to the engine with the aid of fresh air flowing through the carbon canister.

2. Description of the Related Art

As is known, in current motor vehicles powered by fuel such as gasoline or the like, there is equipped a carbon canister is that captures the fuel vapors from the fuel tank and prevents them from escaping into the atmosphere. That is, when the engine shuts off, fuel vapors flow from the fuel tank into the carbon canister. The activated charcoal in the carbon canister traps or adsorbs the fuel vapors. Later, when the engine starts, fresh air flows through the carbon canister and picks up the fuel vapors. The air with the trapped fuel vapor then flows into the intake manifold and becomes part of the air/fuel mixture entering the engine cylinder. Running the engine purges the fuel vapor from the carbon canister, which revives the activated charcoal in the canister.

As the carbon canister used in the evaporative control system, various types have been proposed and put into practical use. Some are shown in Japanese Laid-open Patent Application (Tokkai) 2002-030998 and Japanese Laid-open Patent Application (Tokkaihei) 10-037812. The carbon canister shown in the former comprises two chambers filled with activated charcoal and a fuel vapor adsorbing section that is provided near an air inlet port for suppressing escape of fuel vapors into the atmosphere through the air inlet port. The carbon canister shown in the latter comprises two carbon canisters that are connected in series.

### SUMMARY OF THE INVENTION

In the carbon canisters disclosed by the above-mentioned Japanese Publications, ideas are embodied in the carbon canister for suppressing or at least minimizing undesired escape of fuel vapors from the carbon canister into the atmosphere. For this purpose, the carbon canister of the former publication provides a fuel vapor adsorbing section near the air inlet port, and the carbon canister of the latter publication has an auxiliary carbon canister.

However, the ideas practically used in the known carbon canisters are based on a purpose of increasing a fuel vapor clearing ability (or fuel vapor air-washing ability) with which the trapped fuel vapor is cleared from the activated charcoal of the carbon canister. In other words, the purpose of the ideas is to effectively clear hydrocarbons (HC) that remain in the carbon canister after each purging of the trapped fuel vapor from the activated charcoal. When considering such purpose, it can be easily recognized that the activated charcoal used as the adsorbing material is of a type that is somewhat poor in fuel vapor adsorbing ability. Thus, when, under such condition, combination of the ability of trapping (or adsorbing) fuel vapors by the activated charcoal and the ability of clearing the trapped fuel vapor from the activated charcoal is required, there is no way except the way of increasing the loading weight of the activated charcoal in the carbon canister. However, in this case, the carbon canister is increased in not only cost but also size. Increased size, that is, bulky construction of the carbon canister would narrow the engine room of the motor vehicle.

Of course, when the activated charcoal is replaced with a high performance one, the ability of adsorbing fuel vapors to the activated charcoal increases. However, in such case, the other ability of clearing trapped fuel vapor from the activated charcoal inevitably lowers, which means increase of hydrocarbons (HC) remaining in the carbon canister after each purging of the trapped fuel vapor. Of course, in this case, the evaporative control system using such carbon canister fails to exhibit a satisfied air pollution suppression performance.

In view of the above, a main object of the present invention is to provide a carbon canister that is free of the above-mentioned drawbacks.

That is, in accordance with the present invention, there is provided a carbon canister which exhibits a balanced performance between the ability of trapping fuel vapor by the activated charcoal and the ability of clearing trapped fuel vapor from the activated charcoal and thus exhibits a satisfied fuel vapor escape suppressing performance without inducing a bulky construction of the same.

In accordance with a first aspect of the present invention, there is provided a carbon canister which comprises a casing including first and second casing parts (2, 3) that are connected in serial through a connecting passage (7) to constitute a main carbon canister section, the second casing part (3) having axially opposed first and second ends, the first end being directly connected to the connecting passage (7); a charge port pipe (9) connected to the first casing part (2), the charge port pipe being adapted to connect to a fuel tank; a purge port pipe (10) connected to the first casing part (2), the purge port pipe being adapted to connect to an intake manifold of an engine; an air inlet pipe (11, 34) fluidly connected to the second casing part (3), the air inlet pipe being adapted to open to the atmosphere; a first type of granulated adsorbing material (14, 19) contained in the first and second casing parts (2, 3); and an additional carbon canister section (CC, 32) provided between the air inlet pipe (11) and the second end of the second casing part (3), the additional carbon canister section containing therein a second type of granulated adsorbing material (23) of which fuel vapor adsorbing/clearing ability is equal to or higher than that of the first type of granulated adsorbing material.

In accordance with a second aspect of the present invention, there is provided a carbon canister which comprises a casing including first and second casing parts (2, 3) that are connected in series through a connecting passage (7) to constitute a main carbon canister section, the second casing part (3) having axially opposed first and second ends, the first end being directly connected to the connecting passage (7); a charge port pipe (9) connected to the first casing part (2), the charge port pipe being adapted to connect to a fuel tank; a purge port pipe (10) connected to the first casing part (2), the purge port pipe being adapted to connect to an intake manifold of an engine; an air inlet pipe (11) connected to the second casing part (3), the air inlet pipe being adapted to open to the atmosphere; a first type of granulated adsorbing material (14, 19) contained in the first and second casing parts (2, 3); and a carbon cartridge (CC) installed in the second casing part (3) at a position between the air inlet pipe (11) and the second end of the second casing part (3), the carbon cartridge (CC) containing therein a second type of granulated adsorbing material (23) of which fuel vapor adsorbing/clearing ability is equal to or higher than that of the first type of granulated adsorbing material.

In accordance with a third aspect of the present invention, there is provided a carbon canister which comprises a casing including first and second casing parts (2, 3) that are connected in series through a connecting passage (7) to constitute a main carbon canister section (31), the second casing part (3) having axially opposed first and second ends, the first end being directly connected to the connecting passage (7); a charge port pipe (9) connected to the first casing part (2), the charge port pipe being adapted to connect to a fuel tank; a purge port pipe (10) connected to the first casing part (2), the purge port pipe being adapted to connect to an intake manifold of an engine; an air inlet pipe (34) fluidly connected to the second casing part (3), the air inlet pipe being adapted to open to the atmosphere; a first type of granulated adsorbing material (14, 19) contained in the first and second casing parts (2, 3); and an auxiliary carbon canister section (32) provided between the air inlet pipe (11) and the second end of the second casing part (3) and connected to the second end of the second casing part (3) through a connecting tube (36), wherein the auxiliary carbon canister section (32) comprises a cylindrical casing (33) having first and second chambers connected in series, the first chamber being connected to the connecting tube (36) and the second chamber being connected to the air inlet pipe (34); a second type of granulated adsorbing material (23) contained in the first chamber, the second type of granulated adsorbing material exhibiting a fuel vapor adsorbing/clearing ability equal to or higher than that of the first type of granulated adsorbing material; a honeycomb adsorbing unit (41) installed in the second chamber of the cylindrical casing (33), the honeycomb adsorbing unit being of a type that exhibits a clearing ability higher than that of the first and second types of granulated adsorbing materials; and a first fuel vapor diffusion space (R1) formed in the cylindrical casing (33) between the first chamber and the connecting tube (36); and a second fuel vapor diffusion space (R2) formed in the cylindrical casing (33) between the second chamber and the air inlet pipe (34).

### BRIEF DESCRIPTION OF THE DRAWINGS

Other objects and advantages of the present invention will become apparent from the following description when taken in conjunction with the accompanying drawings, in which:

FIG. 1 is a sectional view of a carbon canister of a first embodiment of the present invention;

FIG. 2 is a sectional view taken along the line A-A of FIG. 1;

FIG. 3 is an enlarged view of a carbon cartridge installed in a second casing part of the carbon canister of FIG. 1; and

FIG. 4 is a sectional view of a carbon canister of a second embodiment of the present invention.

### DETAILED DESCRIPTION OF THE INVENTION

In the following, carbon canisters 1A and 1B of the present invention will be described in detail with reference to the accompanying drawings.

For ease of understanding, in the following description, various directional terms, such as right, left, upper, lower, rightward and the like, are used. However, such terms are to be understood with respect to only a drawing or drawings on which a corresponding part or portion is shown.

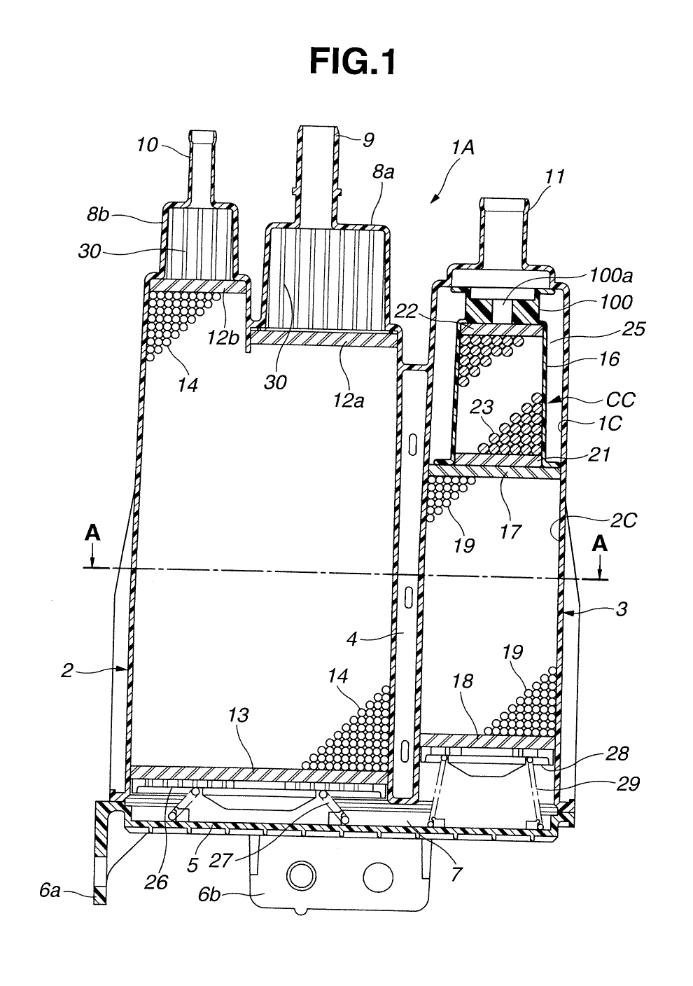

Referring to FIGS. 1, 2 and 3, particularly FIG. 1, there is shown a carbon canister 1A of a first embodiment of the present invention.

As is seen from FIG. 1, the carbon canister 1A, more specifically, a casing of the carbon canister 1A, is made of a molded plastic such as molded polyamide resin or the like.

That is, the carbon canister 1A comprises generally a first casing part 2 that is shaped into a larger rectangular parallelepiped form and a second casing part 3 that is shaped into a smaller rectangular parallelepiped form.

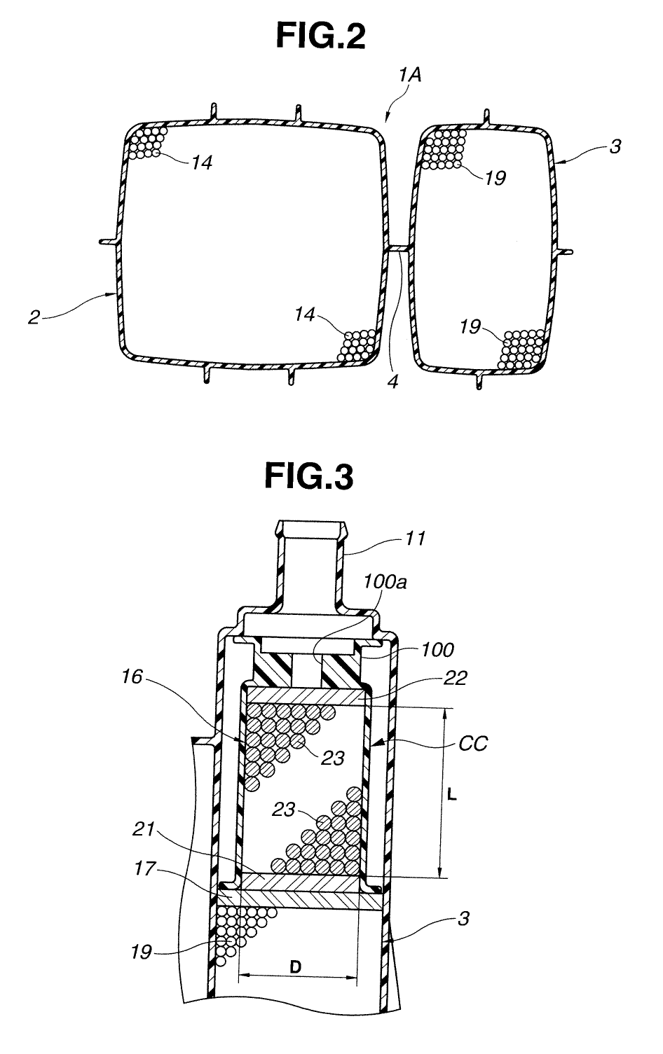

As is understood from FIGS. 1 and 2, the first and second casing parts 2 and 3 are united together through a lib structure 4 formed therebetween.

Referring back to FIG. 1, located below the first and second casing parts 2 and 3 is a lower cover plate 5 that is bonded to lower portions of the casing parts 2 and 3 by a known adhesive. The lower cover plate 5 is made of a molded plastic, such as molded polyamide resin or the like.

With provision of the lower cover plate 5, lower open portions of the first and second casing parts 2 and 3 are concealed.

The interiors of the first and second casing parts 2 and 3 are communicated through a connecting passage 7 that is defined below the first and second casing parts 2 and 3 as will be described in detail hereinafter.

The lower cover plate 5 is integrally formed with brackets 6a and 6b that are used for mounting the carbon canister 1A to a desired position of an associated motor vehicle.

As is seen from FIG. 1, the first and second casing parts 2 and 3 are communicated through the connecting passage 7 that is defined between each of the bottom portions of the first and second casing parts 2 and 3 and the lower cover plate 5. With this connecting passage 7, the interiors of the first and second casing parts 2 and 3 are connected in series.

As will be described hereinafter, through the interiors of the first and second casing parts 2 and 3 connected in series, there flow fuel vapor and fresh air.

As is seen from FIG. 1, each casing part 2 or 3 has a tapered construction that is gradually but slightly tapered toward an upper portion.

The upper portion of the first casing part 2 is formed with larger and smaller projected portions 8a and 8b which are arranged in parallel with respect to a flow passage defined in the first casing part 2. Each projected portion 8a or 8b is formed at an inner wall thereof with axially extending ribs 30 for reinforcing the projected portion 8a or 8b.

The larger projected portion 8a is integrally formed with a charge port pipe 9 to which a fuel vapor inlet tube (not shown) extending from a fuel tank (not shown) is connected. That is, when the engine shuts off, fuel vapor in the fuel tank flows through the fuel vapor inlet tube into the first and second casing parts 2 and 3 and an after-mentioned carbon cartridge CC and is trapped by adsorbing materials packed in the first and second casing parts 2 and 3 and carbon cartridge CC.

The smaller projected portion 8b is integrally formed with a purge port pipe 10 to which a fuel vapor outlet tube (not shown) extending from an intake manifold (not shown) of the engine is connected. That is, under operation of the engine, trapped fuel vapor in the carbon cartridge CC and the second and first casing parts 3 and 2 is picked up by fresh air that flows through the carbon cartridge CC and the two casing parts 3 and 2 and then led to the intake manifold of the engine through the purge port pipe 10 and the fuel vapor outlet tube.

The upper portion of the second casing part 3 is formed with an air inlet pipe 11 through which fresh air is led into the second casing part 3.

To bottoms of the larger and smaller projected portions 8a and 8b, there are fitted respective screen sheets 12a and 12b, and to a bottom of the first casing part 2, there is fitted a screen sheet 13. These screen sheets 12a, 12b and 13 are each made of nonwoven fabric, polyurethane foam or the like.

Within the interior of the first casing part 2, there is packed a given amount of granulated adsorbing material 14 made of activated charcoal.

As is seen from FIG. 1, the interior of the second casing part 3 is partitioned into first (or upper) and second (or lower) chambers 1C and 2C that are connected in series. The first chamber 1C has the air inlet pipe 11 connected thereto.

Within the first chamber 1C, there is installed a cylindrical case 16 that contains therein a high performance granulated adsorbing material 23 made of activated charcoal. The detail of the high performance granulated adsorbing material 23 will be described hereinafter.

Upper and lower openings of the cylindrical case 16 are provided with respective screen sheets 22 and 21 for stably holding the high performance adsorbing material 23 in the cylindrical case 16. The screen sheets 22 and 21 are each made of nonwoven fabric, polyurethane foam or the like.

Between a base portion of the air inlet pipe 11 and the upper end of the cylindrical case 16, there is resiliently installed an elastic holder 100 that has a central opening 100a formed therethrough.

Within the second chamber 2C, there is packed a granulated adsorbing material 19 made of activated charcoal.

It is to be noted that the material 19 is the same as the material 14 packed in the first casing part 2.

Upper and lower portions of the second chamber 2C are provided with respective screen sheets 17 and 18 for stably holding the granulated adsorbing material 19 in the second chamber 2C. The screen sheets 17 and 18 are each made of nonwoven fabric, polyurethane foam or the like.

The cylindrical case 16, the high performance granulated adsorbing material 23 packed in the cylindrical case 16 and the upper and lower screen sheets 22 and 21 constitute an exchangeable carbon cartridge CC.

Upon installation, the interior of the carbon cartridge CC is is communicated with the second chamber 2C of the second casing part 3 through the two screen sheets 21 and 17.

As is seen from the drawing, the flow passage defined in the carbon cartridge CC is narrower than that defined in the second chamber 2C of the second casing part 3.

Under process of assembling the carbon canister 1A, the carbon cartridge CC is put into the first chamber 1C before the second chamber 2C is packed with the granulated adsorbing material 19.

Once the carbon cartridge CC is set in a proper position of the first chamber 1C, the interior of the carbon cartridge CC becomes communicated with the atmosphere through the upper screen sheet 22, the opening 100a of the elastic holder 100 and the air inlet pipe 11. An annular clearance 25 is formed around an outer cylindrical surface of the carbon cartridge CC, as shown.

As is shown in FIG. 1, below the screen sheet 13 of the first casing part 2, there is arranged a plastic grid plate 26. The plastic grid plate 26 has a certain stiffness for stably supporting the screen sheet 13.

Between the plastic grid plate 26 and a left part of the lower cover plate 5, there is compressed a conical spring 27. With the biasing force of the spring 27, the whole mass of the granulated adsorbing material 14 in the first casing part 2 is constantly compressed. That is, due to the work of the spring 27, the whole mass of the granulated adsorbing material 14 is stably held in the first casing part 2.

Below the screen sheet 18 of the second casing part 3, there is arranged another plastic grid plate 28 that has a certain stiffness for stably supporting the screen sheet 18.

Between the plastic grid plate 28 and a right part of the to lower cover plate 5, there is compressed another conical spring 29. With the biasing force of the spring 29, the whole mass of the granulated adsorbing material 19 in the second chamber 2C of the second casing 3 is constantly compressed with a certain force. That is, due to the work of the spring 29, the whole mass of the granulated adsorbing material 19 is stably held in the second chamber 2C of the second casing part 3.

The ribs 30 formed around inner cylindrical walls of the larger and smaller projected portions 8a and 8b serve to stably support the screen sheets 12a and 12b respectively.

Due to provision of the screen sheets 12a, 12b, 13, 17, 18 and the plastic grid plates 26 and 28, leak or spill of the granulated adsorbing materials 14 and 19 from their set positions is assuredly suppressed. Furthermore, due to provision of the springs 27 and 29, the whole mass of the granulated adsorbing material 14 and that of the granulated adsorbing material 19 are stably held in the first and second casing parts 2 and 3.

As is seen FIG. 1, the first and second casing parts 2 and 3 that respectively contain the granulated adsorbing materials 14 and 19 are arranged side by side, and lower open portions of the two casing parts 2 and 3 are connected through the connecting passage 7 that extends laterally.

Thus, as will be described in detail hereinafter, a flow passage defined in the carbon canister 1A for the fuel vapor and fresh air has a shape of character “U”. As is mentioned hereinabove, the flow passage defined by the carbon cartridge CC is narrower than that defined by the second chamber 2C of the second casing part 3.

Referring to FIG. 3, there is shown the detail of the carbon cartridge CC.

As is shown, the high performance granulated adsorbing material 23 is packed in the cylindrical case 16.

In the drawing, the effective length of the compressed mass of the high performance granulated adsorbing material 23 in the cylindrical case 16 is represented by “L” and the effective diameter of the same is represented by “D”.

Inventors have found that the ratio of the effective length “L” relative to the effective diameter “D”, that is, “L/D”, serves as an indicator that indicates a fuel vapor adsorbing/clearing ability of the carbon cartridge CC. In the present invention, the ratio “LID” is set to a range from 1.0 to 2.0. It has been revealed that even if the ratio “L/D” has a value larger than 2.0, remarkable additional effect is not expected.

Although, in the above-mentioned embodiment 1A of the invention, the first and second casing parts 2 and 3 are arranged side by side, the casing parts 2 and 3 may take other arrangement so long as the series connection among the granulated adsorbing material 14 in the first casing part 2, the granulated adsorbing material 19 in the second casing part 3 and the high performance granulated adsorbing material 23 in the carbon cartridge CC is kept. That is, if the above-mentioned series condition is fulfilled, the first casing part 2 and second casing part 3 may be coaxially aligned.

As is mentioned hereinabove, the granulated adsorbing material 19 in the second casing part 3 is the same as the above-mentioned granulated adsorbing material 14 in the first casing part 2.

However, the granulated adsorbing material 19 and 14 is different in performance from the granulated adsorbing material 23 in the carbon cartridge CC.

That is, the granulated adsorbing material 23 in the carbon cartridge CC is of a high performance type.

More specifically, the granulated adsorbing material 14 and 19 for the first and second casing parts 2 and 3 is of a type that s exhibits a fuel vapor adsorbing/clearing ability in the range from 7 g/dL to 11 g/dL in terms of a working capacity (WC) against butane gas under ASTMD5228 test, while the granulated adsorbing material 23 for the carbon cartridge CC is of a type that exhibits the fuel vapor adsorbing/clearing ability of about 15 g/dL.

While, if desired, the granulated adsorbing material 14 and 19 for the first and second casing parts 2 and 3 may be of the same type as that of the high performance granulated adsorbing material 23 for the carbon cartridge CC.

In short, it is important in the present invention to place, near the air inlet pipe 11 or at the inside of the air inlet pipe 11, a given mass of granulated adsorbing material of which fuel vapor adsorbing/clearing ability is higher than or equal to that of the granulated adsorbing material 14 and 19 in the first and second casing parts 2 and 3.

In the following, operation of the carbon canister 1A of the first embodiment of the present invention will be described with the aid of FIG. 1.

When the engine shuts off, fuel vapor in the fuel tank (not shown) flows into the first casing part 2 through the charge port pipe 9 and into the second casing part 3 through the connecting passage 7 and finally into the carbon cartridge CC.

During this flow, the fuel vapor is successively trapped or adsorbed by the granulated adsorbing material 14 in the first casing part 2, the granulated adsorbing material 19 in the second casing part 3 and the high performance granulated adsorbing material 23 in the carbon cartridge CC. That is, under stopping of the engine, the fuel vapor is being trapped by the adsorbing materials 14, 19 and 23.

While, when the engine starts, fresh air is forced to flow, through the air inlet pipe 11, the carbon cartridge CC, the lower chamber of the second casing part 3, the connecting passage 7, the first casing part 2 and the purge port pipe 10, into the intake manifold of the engine. With this fresh air flow, the fuel vapor kept trapped in the carbon cartridge CC, the second casing part 3 and the first casing part 2 is picked up by the fresh air and led through the purge port pipe 10 into the intake manifold together with the fresh air and burnt by the engine. Running the engine purges the fuel vapor from carbon canister 1A and thus revives the activated charcoals in the canister 1A.

In order to establish the present invention, the inventors conducted various experiments.

By the experiments, the inventors have found that even if the purge of the fuel vapor from the carbon canister 1A is carried out, some amount of fuel vapor is remained in the first and second casing parts 2 and 3, and the amount of remaining fuel vapor at an area near or the inside of the air inlet pipe 11 is relatively small. More specifically, it has been revealed that the concentration of the fuel vapor at that near area gradually reduces as a distance to the air inlet pipe 11 reduces.

Furthermore, the inventors have found that due to difference in concentration of the fuel vapor between the near area that is near the air inlet pipe 11 and the distant area that is distant from the air inlet pipe 11, there is produced a migration of trapped fuel vapor from the distant area to the near area by reason of adsorption of equilibrium, which inevitably increases escape of the fuel vapor from the carbon canister 1A into the atmosphere.

In order to suppress or at least minimize such undesired escape of the fuel vapor into the atmosphere, the carbon cartridge CC containing the high performance adsorbing material 23 is installed at the near area in the present invention.

Thus, even if the concentration of the fuel vapor at the near area is high due to the above-mentioned reason, the high performance granulated adsorbing material 23 sufficiently adsorbs the excessive fuel vapor thereby to suppress or at least minimize the escape of the fuel vapor into the atmosphere.

For verifying the above, the inventors carried out several experiments by producing test examples in which the granulated adsorbing material 14 and 19 for the first and second casing parts 2 and 3 is of a type that shows the fuel vapor adsorbing/clearing ability of about 11 g/dL (butane gas), the high performance granulated adsorbing material 23 for the carbon to cartridge CC is of a type that shows the fuel vapor adsorbing/clearing ability of about 15 g/dL (butane gas) and the ratio “L/D” of the cylindrical mass of the granulated adsorbing material 23 is about 1.0 to about 2.0. As the result of the experiments, the inventors have found that a satisfied fuel vapor escape suppressing effect is obtained by only a few tens of cubic centimeters of the high performance granulated adsorbing material 23. The experiments have further revealed that usage of the high performance granulated adsorbing material 23 by about 1.5% to 2.0% in volume to the entire volume of the first and second casing parts 2 and 3 brings about a satisfied fuel vapor escape suppressing effect. This means that if the entire volume of the carbon canister 1A is two liters, the satisfied fuel vapor escape suppressing effect is obtained by only 30 to 50 cubic centimeters of the high performance granulated adsorbing material 23.

As is described hereinabove, the carbon canister 1A of the first embodiment of the present invention can suppress or at least minimize the undesired escape of fuel vapor into the atmosphere by installing a small amount of high performance granulated adsorbing material 23 at the inside of the air inlet pipe 11. Due to employment of the small amount of the adsorbing material 23, compact construction is achieved by the second casing part 3 and thus by the entire construction of the carbon canister 1A of the invention.

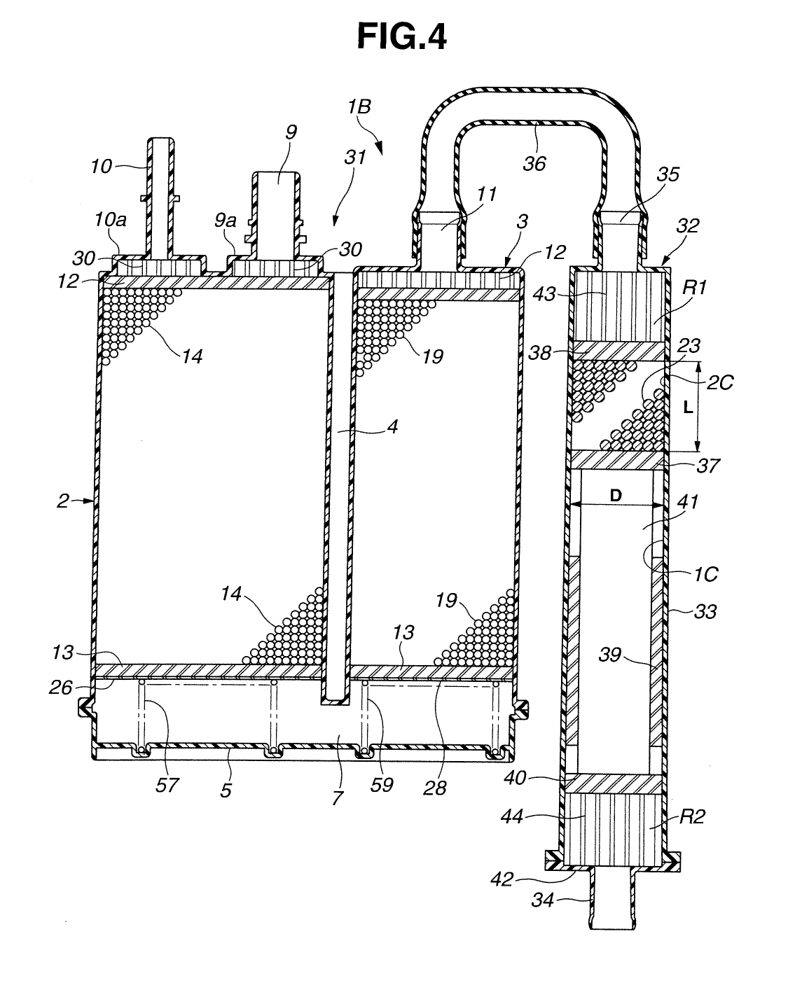

Referring to FIG. 4, there is shown a second embodiment 1B of the carbon canister of the present invention.

As shown in the drawing, the carbon canister 1B of this second embodiment is of a coupled type which comprises generally a main carbon canister section 31 and an auxiliary carbon canister section 32 which are connected through a connecting tube 36.

Like the carbon canister 1A of the above-mentioned first embodiment, the carbon canister 1B of this second embodiment is made of a molded plastic such as molded polyamide resin or the like.

The main carbon canister section 31 comprises generally a first casing part 2 that is shaped into a larger rectangular parallelepiped form and a second casing part 3 that is shaped into a smaller rectangular parallelepiped form.

The first and second casing parts 2 and 3 are united together through a lib structure 4 formed therebetween.

Located below the first and second casing parts 2 and 3 is a lower cover plate 5 that is bonded to lower portions of the casing parts 2 and 3 by an adhesive. The lower cover plate 5 is made of a molded plastic, such as molded polyamide resin or the like.

With provision of the lower cover plate 5, lower open portions of the first and second casing parts 2 and 3 are concealed.

The interiors of the first and second casing parts 2 and 3 are communicated through a connecting passage 7 that is provided below the first and second casing parts 2 and 3 as will be described in detail hereinafter.

As is seen from FIG. 4, the first and second casing parts 2 and 3 are fluidly connected through the connecting passage 7 that is defined between each of the bottom portions of the first and second casing parts 2 and 3 and the lower cover plate 5. With presence of this connecting passage 7, the interiors of the first and second casing parts 2 and 3 are connected in series.

As will be described hereinafter, through the interiors of the first and second casing parts 2 and 3 connected in series, there flow fuel vapor and fresh air.

The upper portion of the first casing part 2 is integrally formed with both a charge port pipe 9 and a purge port pipe 10 each having an enlarged base portion 9a or 10a. As shown, each enlarged base portion 9a or 10a is formed at an inner cylindrical surface thereof with axially extending ribs 30 for reinforcing the base portion 9a or 10.

Like in the carbon canister 1A of the first embodiment, to the charge port pipe 9, there is connected a fuel vapor inlet tube (not shown) that extends to a fuel tank (not shown). That is, when the engine shuts off, fuel vapor in the fuel tank flows through the fuel vapor inlet tube into the first and second casing is parts 2 and 3 and the auxiliary carbon canister 32 and is trapped by adsorbing materials packed in the first and second casing parts 2 and 3 and the auxiliary carbon canister 32 respectively.

To the purge port pipe 10, there is connected a fuel vapor outlet tube (not shown) that extends to an intake manifold of the engine. That is, under operation of the engine, the trapped fuel vapor in the auxiliary carbon canister 32 and second and first casing parts 3 and 2 is picked by fresh air flowing through the auxiliary carbon canister 32 and second and first casing parts 3 and 2 and then led to the intake manifold of the engine through the purge port pipe 10 and the fuel vapor outlet tube.

Within the first casing part 2, there is packed a given amount of granulated adsorbing material 14 made of activated charcoal. Upper and lower screen sheets 12 and 13 are arranged to put therebetween the mass of the adsorbing material 14.

Within the second casing part 3, there is packed a given amount of granulated adsorbing material 19 made of activated charcoal. Upper and lower screen sheets 12 and 13 are arranged in the second casing part 3 in a manner to put therebetween the mass of the adsorbing material 19.

Below the screen sheet 13 of the first casing part 2, there is provided a plastic grid plate 26 and below the screen sheet 13 of the second casing part 3, there is provided another plastic grid plate 28.

Between the plastic grid plate 26 and a left part of the lower cover plate 5, there is compressed a coil spring 57. With the biasing force of the spring 57, the whole mass of the granulated adsorbing material 14 is constantly compressed and stably held in the first casing part 2.

Between the plastic grid plate 28 and a right part of the lower cover plate 5, there is compressed another coil spring 59. With the biasing force of the spring 59, the whole mass of the granulated adsorbing material 19 is constantly compressed and stably held in the second casing part 3.

It is to be noted that the granulated adsorbing materials 14 and 19 are the same like in the carbon canister 1A of the first embodiment.

The upper portion of the second casing part 3 is formed with an inlet pipe 11 to which a connecting tube 36 is connected.

The auxiliary carbon canister section 32 comprises a cylindrical casing 33 made of a molded polyamide resin or the like.

For the purpose that will be clarified hereinafter, the interior of the cylindrical casing 33 is partitioned into first and second chambers 1C and 2C that are connected in series.

The cylindrical casing 33 is integrally formed at an upper end thereof with a connecting pipe 35. The cylindrical casing 33 is provided at a lower end thereof with an air inlet pipe 34 that is integral with a circular cover 42. The cover 42 is bonded or welded to the lower end of the cylindrical casing 33. The connecting pipe 35 is connected to the above-mentioned inlet pipe 11 through the connecting tube 36.

It is to be noted that the first chamber 1C is provided near the air inlet pipe 34 and the second chamber 2C is provided near the connecting pipe 35.

As shown, the upper and lower portions of the cylindrical casing 33 are formed at their inner cylindrical surfaces with axially extending ribs 43 and 44 for reinforcing the casing 33.

Within a lower part of the second chamber 2C of the cylindrical casing 33, there is packed a given amount of high performance granulated adsorbing material 23 that is the same as the material 23 used in the above-mentioned first embodiment 1A.

Upper and lower screen sheets 38 and 37 are arranged in the second chamber 2C in a manner to put therebetween the mass of the high performance granulated adsorbing material 23.

In FIG. 4, the effective length of the compressed mass of the high performance granulated adsorbing material 23 is represented by “L” and the effective diameter of the same is is represented by “D”.

Also in this second embodiment 1B, the ratio of the effective length “L” relative to the effective diameter “D”, that is, “LID”, is set to a range from 1.0 to 2.0.

Within the first chamber 1C of the cylindrical casing 33, there is installed a honeycomb adsorbing unit 41 that contains activated charcoal. The honeycomb adsorbing unit 41 is a cylindrical body with a honeycomb construction, that is produced by shaping power of activated charcoal into a cylindrical honeycomb body with the aid of a suitable binder.

The honeycomb adsorbing unit 41 has a clearing ability higher than that of the above-mentioned granulated adsorbing materials 14, 19 and 23. A cylindrical screen sheet 39 is put around the honeycomb adsorbing unit 41 and a screen sheet 40 is put below the unit 41.

It is to be noted that the mass of high performance granulated adsorbing material 23 and the honeycomb adsorbing unit 41 are stably held in the cylindrical casing 33 due to a softly holding function possessed by the screen sheets 38, 37, 33 and 40.

Indicated by references R1 and R2 are cylindrical spaces that are formed in upper and lower portions of the interior of the cylindrical casing 33. More specifically, the spaces R1 and R2 are the spaces surrounded by the ribs 43 and 44. The spaces R1 and R2 function as fuel vapor diffusion chambers for the fuel vapor remaining in the main carbon canister section 31.

In the following, operation of the carbon canister 1B of the second embodiment will be described with the aid of FIG. 4.

When the engine shuts off, fuel vapor in the fuel tank (not shown) flows into the first casing part 2 through the charge port pipe 9 and into the second casing part 3 through the connecting passage 7 and finally into the auxiliary carbon canister section 32 through the tube 36.

During this flow, the fuel vapor is successively trapped or adsorbed by the granulated adsorbing material 14 in the first casing part 2, the granulated adsorbing material 19 in the second casing part 3, the high performance granulated adsorbing material 23 in the auxiliary carbon canister section 32 and the honeycomb adsorbing unit 41 in the auxiliary carbon canister section 32. That is, under stopping of the engine, the fuel vapor is kept trapped by the adsorbing materials 14, 19 and 23 and the honeycomb adsorbing unit 41.

While, when the engine starts, fresh air is forced to flow, through the air inlet pipe 34, the auxiliary carbon canister section 32, the second casing part 3, the connecting passage 7, the first casing part 2 and the purge port pipe 10, into the intake manifold of the engine. With this fresh air flow, the fuel vapor kept trapped in the auxiliary carbon canister section 32, the second casing 3 and the first casing part 2 is picked up by the fresh air and led through the purge port 10 into the intake manifold together with the fresh air and burnt by the engine. Running the engine purges the fuel vapor from the carbon canister 1B and thus revives the activated charcoals in the canister 1B.

As will be understood from the above description, in the second embodiment 1B, the auxiliary carbon canister section 32 is employed in place of the carbon cartridge CC employed in the first embodiment 1A.

Because of employment of the auxiliary carbon canister section 32 that includes the honeycomb adsorbing unit 41 and the adsorbing part containing the high performance granulated adsorbing material 23, the carbon canister 1B of the second embodiment exhibits the fuel vapor adsorbing/clearing ability higher than that of the carbon canister 1A of the first embodiment.

Furthermore, since, in the carbon canister 1B of the second embodiment, the spaces R1 and R2 in the auxiliary carbon canister section 32 serve as fuel vapor diffusion chambers, not only escape of the fuel vapor from the main carbon canister section 31 to the open air but also diffusion and escape of air that has released the fuel vapor are suppressed or at least minimized.

The entire contents of Japanese Patent Application 2010-142216 filed Jun. 23, 2010 are incorporated herein by reference.

Although the invention has been described above with reference to embodiments of the invention, the invention is not limited to such embodiments as described above. Various modifications and variations of such embodiments may be carried out by those skilled in the art, in light of the above description.

What is claimed is:

1. A carbon canister comprising:
a casing including first and second casing parts that are connected in serial through a connecting passage to constitute a main carbon canister section, the second casing part having axially opposed first and second ends, the first end being directly connected to the connecting passage;
a charge port pipe connected to the first casing part, the charge port pipe being adapted to connect to a fuel tank;
a purge port pipe connected to the first casing part, the purge port pipe being adapted to connect to an intake manifold of an engine;
an air inlet pipe fluidly connected to the second casing part, the air inlet pipe being adapted to open to the atmosphere;
a first type of granulated adsorbing material contained in the first and second casing parts; and
an additional carbon canister section provided between the air inlet pipe and the second end of the second casing part, the additional carbon canister section containing therein a second type of granulated adsorbing material of which fuel vapor adsorbing/clearing ability is equal to or higher than that of the first type of granulated adsorbing material.

2. A carbon canister as claimed in claim 1, in which the second type of granulated adsorbing material is packed in a cylindrical portion of which effective axial length is L and of which effective diameter is D, the ratio LID being a value ranging from 1.0 to 2.0.

3. A carbon canister as claimed in claim 2, in which the first type of granulated adsorbing material exhibits the fuel vapor adsorbing/clearing ability in the range from 7 g/dL to 11 g/dL in terms of a working capacity against butane gas under ASTM test, and the second type of adsorbing material exhibits the fuel vapor adsorbing/clearing ability of about 15 g/dL.

4. A carbon canister as claimed in claim 3, in which the fuel vapor adsorbing/clearing ability of the second type of granulated adsorbing material is higher than that of the first type of granulated adsorbing material.

5. A carbon canister as claimed in claim 3, in which the additional carbon canister section is installed in the second casing part in the vicinity of the air inlet pipe.

6. A carbon canister as claimed in claim 5, in which the additional carbon canister section is formed into an exchangeable is carbon cartridge.

7. A carbon canister as claimed in claim 3, in which the additional carbon canister section is connected to the second end of the second casing part through a connecting tube.

8. A carbon canister as claimed in claim 7, in which the additional carbon canister section comprises:
a cylindrical casing having first and second chambers connected in series, the first chamber being connected to the connecting tube and the second chamber being connected to the air inlet pipe, the first chamber containing therein the second type of granulated adsorbing material; and
a honeycomb adsorbing unit installed in the second chamber of the cylindrical casing, the honeycomb adsorbing unit being of a type that exhibits a clearing ability higher than that of the first and second types of granulated adsorbing material.

9. A carbon canister as claimed in claim 8, in which the cylindrical casing has at a portion between the first chamber and the connecting tube a first fuel vapor diffusion chamber and at a portion between the second chamber and the air inlet pipe a second fuel vapor diffusion chamber.

10. A carbon canister comprising:
a casing including first and second casing parts that are connected in series through a connecting passage to constitute a main carbon canister section, the second casing part having axially opposed first and second ends, the first end being directly connected to the connecting passage;
a charge port pipe connected to the first casing part, the charge port pipe being adapted to connect to a fuel tank;
is a purge port pipe connected to the first casing part, the purge port pipe being adapted to connect to an intake manifold of an engine;
an air inlet pipe connected to the second casing part, the air inlet pipe being adapted to open to the atmosphere;
a first type of granulated adsorbing material contained in the first and second casing parts; and
a carbon cartridge installed in the second casing part at a position between the air inlet pipe and the second end of the second casing part, the carbon cartridge containing therein a second type of granulated adsorbing material of which fuel vapor adsorbing/clearing ability is equal to or higher than that of the first type of granulated adsorbing material.

11. A carbon canister comprising:
a casing including first and second casing parts that are connected in series through a connecting passage to constitute a main carbon canister section, the second casing part having axially opposed first and second ends, the first end being directly connected to the connecting passage;
a charge port pipe connected to the first casing part, the charge port pipe being adapted to connect to a fuel tank;
a purge port pipe connected to the first casing part, the purge port pipe being adapted to connect to an intake manifold of an engine;
an air inlet pipe fluidly connected to the second casing part, the air inlet pipe being adapted to open to the atmosphere;
a first type of granulated adsorbing material contained in the first and second casing parts; and
an auxiliary carbon canister section provided between the air inlet pipe and the second end of the second casing part and connected to the second end of the second casing part through a connecting tube,
wherein the auxiliary carbon canister section comprises:
a cylindrical casing having first and second chambers connected in series, the first chamber being connected to the connecting tube and the second chamber being connected to the air inlet pipe;
a second type of granulated adsorbing material contained in the first chamber, the second type of granulated adsorbing material exhibiting a fuel vapor adsorbing/clearing ability equal to or higher than that of the first type of granulated adsorbing material;
a honeycomb adsorbing unit installed in the second chamber of the cylindrical casing, the honeycomb adsorbing unit being of a type that exhibits a clearing ability higher than that of the first and second types of granulated adsorbing materials; and
a first fuel vapor diffusion space formed in the cylindrical casing between the first chamber and the connecting tube; and
a second fuel vapor diffusion space formed in the cylindrical casing between the second chamber and the air inlet pipe.
